(19) United States
(12) Patent Application Publication
(10) Pub. No.: US 2025/0336040 A1
(43) Pub. Date: Oct. 30, 2025

(54) TEMPORAL REFERENCING NETWORK FOR VIDEO PROCESSING APPLICATIONS

(71) Applicant: Samsung Electronics Co., Ltd., Suwon-si (KR)

(72) Inventors: Aparajith Srinivasan, Irvine, CA (US); Chenguang Liu, Tustin, CA (US)

(21) Appl. No.: 19/175,775

(22) Filed: Apr. 10, 2025

Related U.S. Application Data
(60) Provisional application No. 63/638,213, filed on Apr. 24, 2024.

(51) Int. Cl. G06T 5/60; G06T 7/246

(52) U.S. Cl. CPC G06T 5/60; G06T 7/251; G06T 2207/20084

(57) ABSTRACT

An image processing network for image colorization, image color enhancement, image super resolution, or any similar image-to-image processing is converted into an automatic video processing network with temporal stability by addition of a temporal referencing network (TRN). The implementation of the image processing network may remain unmodified, with the temporal information added based on the TRN. The TRN is configured to add temporal information to an input and to an output to an image processing network. The temporal information added to the input and the output includes multiple temporal reference maps generated for one or more input images and one or more output images of the image processing network. Temporal relations are determined based on application of the multiple temporal reference maps for the one or more input images to a recurrent network of the TRN.

### CROSS-REFERENCE TO RELATED AND CLAIM OF PRIORITY

The present application claims priority under 35 U.S.C. § 119(e) to U.S. Provisional Patent Application No. 63/638,213 filed on Apr. 24, 2024, which is hereby incorporated by reference in its entirety.

### TECHNICAL FIELD

This disclosure relates generally to video processing. More specifically, this disclosure relates to adapting image processing networks for use in video processing without flicker in the processed video.

### BACKGROUND

Current entertainment and media content is realistic and vivid, making the user live the moment when watching video content. One of the main aspects of this vivid experience is the bright and rich array of colors that an expert colorist can give to the content, to please the user's eyes. The viewer becomes immersed while watching videos that show the surrounding moving world.

Color makes any image content more attractive, and is one of the most important aspects of contemporary imaging media. Old video content from movies and other sources from (for example) the 1950s and prior lacks realism and emotional depth due to the lack of color, even though the media may convey the idea of what the director attempts to portray. Old video content has a lot of information and entertainment that is not readily acceptable today world because of the lack of color.

Hence, there is a need to improve colorization of black and white video content as well as other image processing such as image color enhancement, image super resolution, and the like.

### SUMMARY

This disclosure relates to eliminating temporal artifacts such as flicker from video processed using an image processing network.

In a first embodiment, a method includes configuring a temporal referencing network (TRN) to add temporal information to an input to an image processing network and to an output of the image processing network. Adding the temporal information to the input and the output includes generating multiple temporal reference maps for one or more input images and one or more output images of the image processing network. The method also includes determining one or more temporal relations based on applying the multiple temporal reference maps for the one or more input images to a recurrent network of the TRN. The method further includes converting, based on the TRN, the image processing network into an automatic video processing network with temporal stability.

Any single one or any combination of the following features may be used with the first embodiment. An implementation of the image processing network may remain unmodified, with the temporal information added to the image processing network based on the TRN. The image processing network may include at least one of an image colorization network, an image color enhancing network, an image super resolution network, or any similar image-to-image network. The multiple temporal reference maps may include, for a current timestep t, an input temporal reference imagemap from the TRN for the current timestep t and an output temporal reference imagemap from the TRN for the current timestep t. Converting the image processing network into the automatic video processing network with temporal stability based on the TRN may include adding, for an input image at the current timestep t, the input temporal reference map from the TRN for the current timestep t to the input image to generate an input to the image processing network. Converting the image processing network into the automatic video processing network with temporal stability based on the TRN may also include adding the output temporal reference map from the TRN for the current timestep t to an output of the image processing network to generate an output of a pipeline comprising the TRN and the image processing network. Configuring a temporal referencing network (TRN) to add the temporal information to the input to the image processing network and the output of an image processing network may include generating the input temporal reference map from the TRN and the output temporal reference map from the TRN based on an input temporal reference image from the TRN for a previous timestep t−1, an output temporal reference image from the TRN for the previous timestep t−1, and an output from the pipeline for the previous timestep t−1. Generating the input temporal reference image from the TRN and the output temporal reference image from the TRN may include performing output-reference (OR) fusion of the input temporal reference image from the TRN for the previous timestep t−1, the output temporal reference image from the TRN for the previous timestep t−1, and the output from the pipeline for the previous timestep t−1. Generating the input temporal reference image from the TRN and the output temporal reference image from the TRN may also include operating on an output of the OR fusion with a recurrent convolutional encoder-decoder network (U-Net) to produce outputs used to generate the input temporal reference map from the TRN for the current timestep t and the output temporal reference map from the TRN for the current timestep t.

In a second embodiment, an electronic device includes at least one processing device. The at least one processing device is configured to configure a temporal referencing network (TRN) to add temporal information to an input to an image processing network and to an output of the image processing network. Adding the temporal information to the input and the output includes generating multiple temporal reference maps for one or more input images and one or more output images of the image processing network. The at least one processing device is also configured to determine one or more temporal relations based on applying the multiple temporal reference maps for the one or more input images to a recurrent network of the TRN. The at least one processing device is further configured to convert, based on the TRN, the image processing network into an automatic video processing network with temporal stability.

Any single one or any combination of the following features may be used with the second embodiment. An implementation of the image processing network may remain unmodified, with the temporal information added to the image processing network based on the TRN. The image processing network may include at least one of an image colorization network, an image color enhancing network, an image super resolution network, or any similar image-to-image network. The multiple temporal reference maps may include, for a current timestep t, an input temporal reference imagemap from the TRN for the current timestep t and an output temporal reference imagemap from the TRN for the current timestep t. Converting the image processing network into the automatic video processing network with temporal stability based on the TRN may include adding, for an input image at the current timestep t, the input temporal reference map from the TRN for the current timestep t to the input image to generate an input to the image processing network. Converting the image processing network into the automatic video processing network with temporal stability based on the TRN may also include adding the output temporal reference map from the TRN for the current timestep t to an output of the image processing network to generate an output of a pipeline comprising the TRN and the image processing network. Configuring a temporal referencing network (TRN) to add the temporal information to the input to the image processing network and the output of an image processing network may include generating the input temporal reference map from the TRN and the output temporal reference map from the TRN based on an input temporal reference image from the TRN for a previous timestep t−1, an output temporal reference image from the TRN for the previous timestep t−1, and an output from the pipeline for the previous timestep t−1. Generating the input temporal reference image from the TRN and the output temporal reference image from the TRN may include performing output-reference (OR) fusion of the input temporal reference image from the TRN for the previous timestep t−1, the output temporal reference image from the TRN for the previous timestep t−1, and the output from the pipeline for the previous timestep t−1. Generating the input temporal reference image from the TRN and the output temporal reference image from the TRN may also include operating on an output of the OR fusion with a recurrent convolutional encoder-decoder network (U-Net) to produce outputs used to generate the input temporal reference map from the TRN for the current timestep t and the output temporal reference map from the TRN for the current timestep t.

In a third embodiment, a non-transitory machine readable medium contains instructions that, when executed, cause at least one processing device of an electronic device to configure a temporal referencing network (TRN) to add temporal information to an input to an image processing network and to an output of the image processing network. Adding the temporal information to the input and the output includes generating multiple temporal reference maps for one or more input images and one or more output images of the image processing network. The instructions, when executed, also cause the at least one processing device of the electronic device to determine one or more temporal relations based on applying the multiple temporal reference maps for the one or more input images to a recurrent network of the TRN. The instructions, when executed, further cause the at least one processing device of the electronic device to convert, based on the TRN, the image processing network into an automatic video processing network with temporal stability.

Any single one or any combination of the following features may be used with the third embodiment. An implementation of the image processing network may remain unmodified, with the temporal information added to the image processing network based on the TRN. The image processing network may include at least one of an image colorization network, an image color enhancing network, an image super resolution network, or any similar image-to-image network. The multiple temporal reference maps may include, for a current timestep t, an input temporal reference imagemap from the TRN for the current timestep t and an output temporal reference imagemap from the TRN for the current timestep t. Converting the image processing network into the automatic video processing network with temporal stability based on the TRN may include adding, for an input image at the current timestep t, the input temporal reference map from the TRN for the current timestep t to the input image to generate an input to the image processing network. Converting the image processing network into the automatic video processing network with temporal stability based on the TRN may also include adding the output temporal reference map from the TRN for the current timestep t to an output of the image processing network to generate an output of a pipeline comprising the TRN and the image processing network. Configuring a temporal referencing network (TRN) to add the temporal information to the input to the image processing network and the output of an image processing network may include generating the input temporal reference map from the TRN and the output temporal reference map from the TRN based on an input temporal reference image from the TRN for a previous timestep t−1, an output temporal reference image from the TRN for the previous timestep t−1, and an output from the pipeline for the previous timestep t−1. Generating the input temporal reference image from the TRN and the output temporal reference image from the TRN may include performing output-reference (OR) fusion of the input temporal reference image from the TRN for the previous timestep t−1, the output temporal reference image from the TRN for the previous timestep t−1, and the output from the pipeline for the previous timestep t−1. Generating the input temporal reference image from the TRN and the output temporal reference image from the TRN may also include operating on an output of the OR fusion with a recurrent convolutional encoder-decoder network (U-Net) to produce outputs used to generate the input temporal reference map from the TRN for the current timestep t and the output temporal reference map from the TRN for the current timestep t.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration 100 that may be employed in connection with a temporal referencing network for video processing using an image processing network in accordance with this disclosure;

FIG. 2 illustrates an example process of utilizing a temporal referencing network for video processing with an image processing network in accordance with this disclosure;

FIG. 3 is a diagram illustrating a pipeline employing a temporal referencing network for video processing using an image processing network in accordance with this disclosure;

FIG. 4 is a basic diagram illustrating the TRN of FIG. 3 in greater detail;

FIG. 5 illustrates the structure of the OR Fusion block of FIG. 4 in greater detail;

FIG. 5A illustrates the structure of a ConvNeXt block, of the type depicted in FIG. 5;

FIG. 6 illustrates the structure of the reference Head blocks, Rin Head and Rout Head, of FIG. 4 in greater detail;

FIG. 7 illustrates the structure of the Recurrent U-Net of FIG. 4 in greater detail; and

FIG. 8 illustrates the structure of a recurrent convolution layer for use in the Recurrent U-Net of FIGS. 4 and 7.

### DETAILED DESCRIPTION

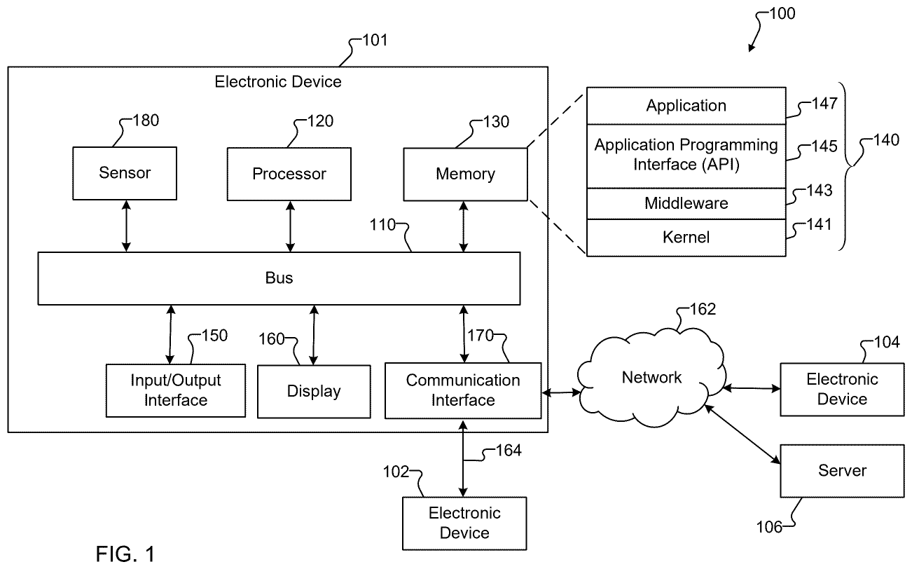

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

With an abundance of black and white video content, processing the content to suit the user is needed. Some applications of the present disclosure include colorizing a grayscale video, dehazing a hazed video, upscaling a low-resolution video, and so on. Such non-linear tasks can be solved using deep neural networks.

One problem in black and white video colorization is the conversion of a single gray scale pixel to three values: red, green, and blue (R, G, B).

Image colorization can be an image-to-image problem, for which there is research. But while videos are just a sequence of images, image colorization networks are not effective for video colorization as the result is often temporal instability of the colors. As a result, video colorization networks work on optimizing temporal stability in colorization. Some methods in video colorization include (a) automatic colorization, in which a whole gray-scale video is colorized by a model, and (b) exemplar-based colorization, in which one or more reference frames are used to colorize a gray-scale video. Automatic colorization models may not need any reference, but also may not produce colorful results. Exemplar-based colorization methods produce vivid colors, but may require reference frames. As noted above, image colorization models that produce colorful, realistic and vivid results are often not useful for video colorization.

Because using an image processing model on videos tends to cause a lot of temporal flickering, which is unappealing to watch for the viewers, de-flickering networks stabilize a temporally flickering video are employed as an alternative to video processing-specific networks. Some drawbacks of de-flickering networks are that real-time processing is infeasible, since the whole video is required as the input. Video processing networks are much larger in size compared to equivalent image processing network, and some models require bi-directional processing of the whole video.

The present disclosure includes a temporal processing network (TPN) (a/k/a temporal referencing network (TRN)) that can convert any image colorization model into an exemplar-based video colorization model.

FIG. 1 illustrates an example network configuration 100 that may be employed in connection with a temporal referencing network for video processing using an image processing network in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to eliminating temporal artifacts from video.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to eliminating temporal artifacts from video. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the electronic device 101 and/or the server 106 may perform various operations related to eliminating temporal artifacts from video. For example, the electronic device 101 may be employed to consume colorized video content, while the server 106 may be configured to implement a temporal referencing network for video colorization as described below, generating video content for consumption on the electronic device 101.

Although FIG. 1 illustrates one example of a network configuration 100 including a server 106 configured to implement a temporal referencing network for video colorization, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

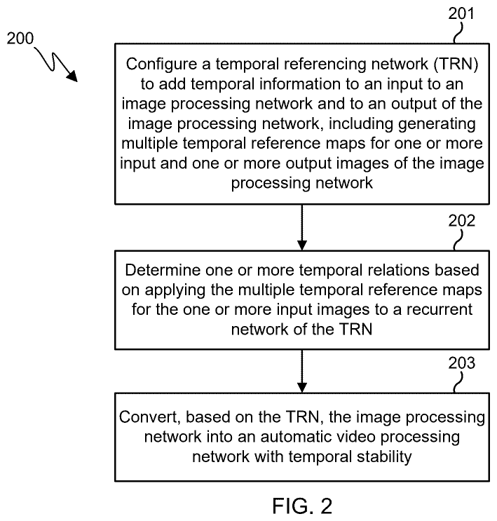

FIG. 2 illustrates an example process 200 of utilizing a temporal referencing network for video processing with an image processing network in accordance with this disclosure. For case of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 begins with configuring a temporal referencing network (TRN) to add temporal information to an input to an image processing network and to an output of the image processing network (step 201). Adding the temporal information to the input and the output includes generating multiple temporal reference maps for one or more input images and one or more output images of the image processing network. The implementation of the image processing network may remain unmodified, with the temporal information added to the image processing network based on the TRN. The image processing network may include an image colorization network, an image color enhancing network, an image super resolution network, or any similar image-to-image network. The multiple temporal reference maps may comprise, for a current timestep t, an input temporal reference map from the TRN for the current timestep t and an output temporal reference map from the TRN for the current timestep t. Configuring a temporal referencing network (TRN) to add the temporal information to the input to the image processing network and the output of an image processing network may include generating the input temporal reference map from the TRN and the output temporal reference map from the TRN based on an input reference image from the TRN for a previous timestep t−1, an output reference image from the TRN for the previous timestep t−1, and an output from a pipeline that includes the TRN and the image processing network for the previous timestep t−1.

One or more temporal relations are determined based on applying the multiple temporal reference maps for the one or more input images to a recurrent network of the TRN (step 202). Inferencing within the TRN determines the temporal relations. Based on the TRN, the image processing network into an automatic video processing network with temporal stability (step 203). The image processing network may be converted into the automatic video processing network by adding, for an input image at the current timestep t, the input temporal reference map from the TRN for the current timestep t to the input image to generate an input to the image processing network, and adding the output temporal reference map from the TRN for the current timestep t to an output of the image processing network to generate an output of a pipeline including the TRN and the image processing network. Generating the input temporal reference image from the TRN and the output temporal reference image from the TRN may include performing output-reference (OR) fusion of the input reference image from the TRN for the previous timestep t−1, the output reference image from the TRN for the previous timestep t−1, and the output from the pipeline for the previous timestep t−1, and operating on an output of the OR fusion with a recurrent convolutional encoder-decoder network (U-Net) to produce outputs used to generate the input temporal reference map from the TRN for the current timestep t and the output temporal reference map from the TRN for the current timestep t.

Although FIG. 2 illustrates one example of a process 200 of using a temporal referencing network for video colorization, various changes may be made to FIG. 2. For example, while shown as a series of steps, various steps in FIG. 2 could overlap, occur in parallel, occur in a different order, or occur any number of times (including zero times).

In an exemplar-based video colorization approach using a temporal referencing network as described herein, the network colorizes video in a bidirectional manner. Two reference colorized frames may be required to colorize the grayscale frames in between. The model produces accurate results, but may not be entirely suitable for real-time implementation in live broadcasts where the future frames are unknown.

In a video colorization via semantic correspondence framework, for example, the first frame is colorized with a separate colorization network and then acts as the reference frame for the whole video. Even though this approach may be used in real-time, due to a unidirectional flow, some discoloration artifacts occur when the scene is long, with the last frame being very different from the first frame. In addition, this approach may require an extra network for reference colorization.

In some embodiments of the present disclosure, a pipeline may be configured to convert any image colorization framework into an exemplar-based video colorization model. Colorization can be performed in the Lab color space which separates an RGB image into Lightness (L) and color channels (a, b). Lab space can be used, for instance, where the input to a neural network model is an L channel grayscale image and the output is a 2 channel (a, b) image. In some cases, the approach of the present disclosure may use the same Lab color space, while in other cases, any color space which separates the lightness and color channels can be used (e.g., hue, saturation, and value (HSV)).

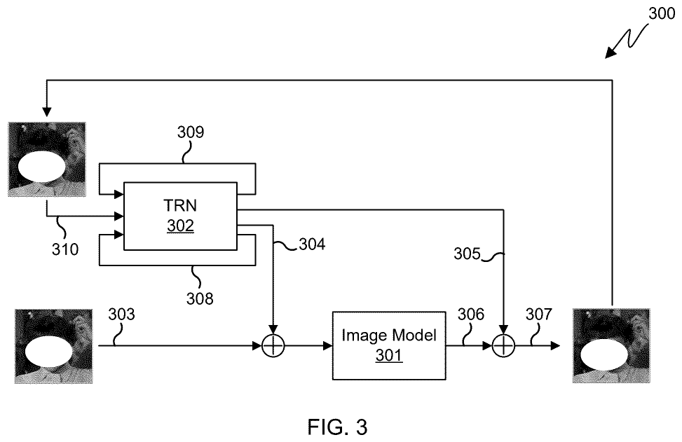

FIG. 3 is a diagram illustrating a pipeline 300 employing a temporal referencing network for video processing using an image processing network in accordance with this disclosure. For case of explanation, the pipeline 300 of FIG. 3 is described as being implemented within the server 106 in the network configuration 100 of FIG. 1, operating interactively with the electronic device 101 to display (for example) colorized black and white video. However, the pipeline 300 may be implemented using any other suitable device(s) and in any other suitable system(s).

The pipeline 300 converts any image processing model (image model 301, a/k/a image processing network) used for applications like image colorization, image dehazing, image super resolution, etc. into an automatic video processing model. The image model 301 augmented by temporal reference maps as described below, which are generated by the temporal referencing network (TRN) 302 in the pipeline 300. The main task of the TRN 302 is to ensure that an image processing model, when applied to video, produces outputs which are temporally stable with no noticeable flickering.

The pipeline 300 of FIG. 3 receives an input frame It 303 at time t within the sequence of frames forming the input video. The TRN 302 produces two temporal reference maps (a/k/a reference images),

$${R}_{t}^{i n} 304 and {R}_{t}^{out} 305 ,$$

at every time t that are used by the image model 301 to process the input frame Iₜ 303 at time t.

$${R}_{t}^{i n} 304$$

is added to the input frame Iₜ 303 input to the image model 301 and

$${R}_{t}^{out} 305$$

is added to the output frame 306 from the image model 301 to obtain the final output frame Oₜ 307 from the pipeline 300. Both temporal reference maps

$${R}_{t}^{i n} 304 and {R}_{t}^{out} 305$$

add temporal information without otherwise modifying the structure of image model 301, which makes the TRN 302 a plug-and-play model that can be added to any image processing pipeline for conversion into a video processing pipeline. As shown, the outputs of TRN 302 are dependent on the previous timestep temporal reference maps,

$${R}_{t - 1}^{in} 308 and {R}_{t - 1}^{out} 309 ,$$

and the previous timestep output frame Oₜ₋₁ 310. The TRN 302 is a recurrent neural network which is trained with backpropagation though time.

The image model 301 can be pre-trained image processing network that is operable for a particular image processing task. The output of the pipeline 300 using the image model 301 can be characterized by the equation:

$${O}_{t} = {g}_{∅} ( {I}_{t} + {R}_{t}^{in} ) + {R}_{t}^{out} ,$$

where g_{Ø} denotes a neural network with trainable parameters Ø, Oₜ is the output frame, Iₜ is the input frame and

$${R}_{t}^{i n} and {R}_{t}^{out}$$

are the input and output temporal reference maps, respectively, at time t.

Although FIG. 3 illustrates one example of a pipeline 300 employing a temporal referencing network for video processing, various changes may be made to FIG. 3. For example, two image models may be employed in sequence, either with a separate TRN for each image model or a single TRN for both image models.

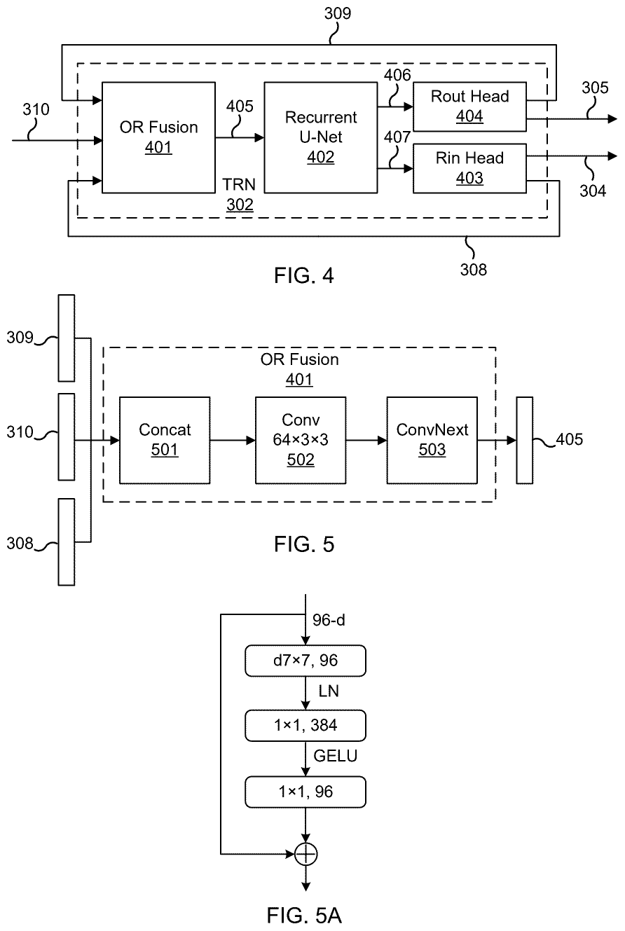

FIG. 4 is a basic diagram illustrating the TRN 302 of FIG. 3 in greater detail. The TRN 302 is the network which produces the temporal reference maps

$${R}_{t}^{i n} 304 and {R}_{t}^{out} 305 ,$$

adding temporal information to the image processing network to change that network into a video processing network. In some embodiments, the temporal reference maps may be only to reduce flickering without changing the image processing ability of the image model. The TRN 302 is characterized by the following:

$$[ {R}_{t}^{in} , {R}_{t}^{out} ] = {f}_{θ} ( {R}_{t - 1}^{in} , {O}_{t - 1} , {R}_{t - 1}^{out} ) ,$$

where f_{θ} is the neural network with trainable parameters θ.

$${R}_{t}^{in} and {R}_{t}^{out}$$

denote the input and output temporal reference maps at time t,

$${R}_{t - 1}^{i n} and {R}_{t - 1}^{out}$$

denote the input and output temporal reference maps at the previous timestep t−1, and Oₜ₋₁ denotes the output image at the previous timestep.

The basic structure of the TRN 302 is shown in FIG. 3. The output reference (OR) Fusion block 401 fuses the temporal reference maps

$${R}_{t - 1}^{i n} and {R}_{t - 1}^{out}$$

and the output Oₜ₋₁ together. The output of the OR Fusion block 401 is passed through a Recurrent U-Net 402, which is a recurrent, fully convolutional encoder/decoder network that processes the output and temporal reference maps at different scales along with temporal memory. The output of the Recurrent U-Net 402 is passed thorough the respective Head blocks, Rin Head 403 and Rout Head 404, to obtain

$${R}_{t}^{i n} and {R}_{t}^{out} ,$$

respectively.

FIG. 5 illustrates the structure of the OR Fusion block 401 of FIG. 4 in greater detail. The OR Fusion block 401 fuses the output Oₜ₋₁ and the temporal reference maps

$${R}_{t - 1}^{i n} and {R}_{t - 1}^{out}$$

together. Concat 501 receives as inputs the temporal reference maps

$${R}_{t - 1}^{i n} and {R}_{t - 1}^{out}$$

and the output Oₜ₋₁ and performs vector concatenation for those inputs. The concatenated vectors are received by conv 502, a convolutional neural network which uses convolution to extract features and detect objects. As shown, conv 502 may include 64 filters with a spatial size of 3×3 pixels. The output of conv 502 is received by ConvNeXt 503, a deep learning model that, as shown in FIG. 5A, includes convolutional layers and fully connected layers (e.g., a 96 channel model with convolutional layer(s), layer normalization (LN), additional convolutional layers, a Gaussian error linear unit (GELu or “GELU”), and then further convolutional layers). The output 405 of the OR Fusion block 401 is input to the Recurrent U-Net 402.

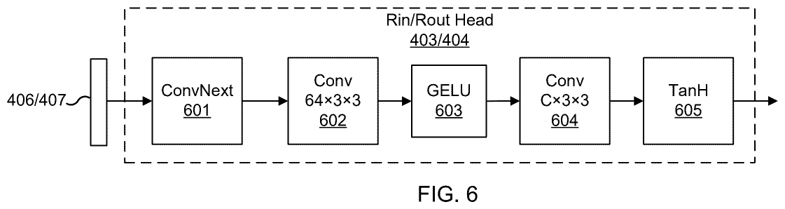

FIG. 6 illustrates the structure of the reference Head blocks, Rin Head 403 and Rout Head 404, of FIG. 4 in greater detail. The structure of FIG. 6 is employed for both the Rin Head 403 and the Rout Head 404. The reference Head block (Rin Head 403 or Rout Head 404) takes the output 406, 407 of the Recurrent U-Net 402 and produces the respective temporal references map

$${R}_{t}^{i n} or {R}_{t}^{out} .$$

The block diagram FIG. 6 of the reference head block includes a ConvNeXt 601, conv 602, GELu 603, and a conv 604. The final convolution has C filters based on the number of channels for the input reference and the output temporal reference maps. For example, if the input to the image model 301 has three channels and the output has two channels, Rin Head 403 would have C=3 and Rout Head 404 would have C=2. The final activation is produced by TanH 605, as the temporal reference maps are added. With an output range [−1, 1], TanH 605 can serve to both add to or subtract from the input/output with the temporal reference maps.

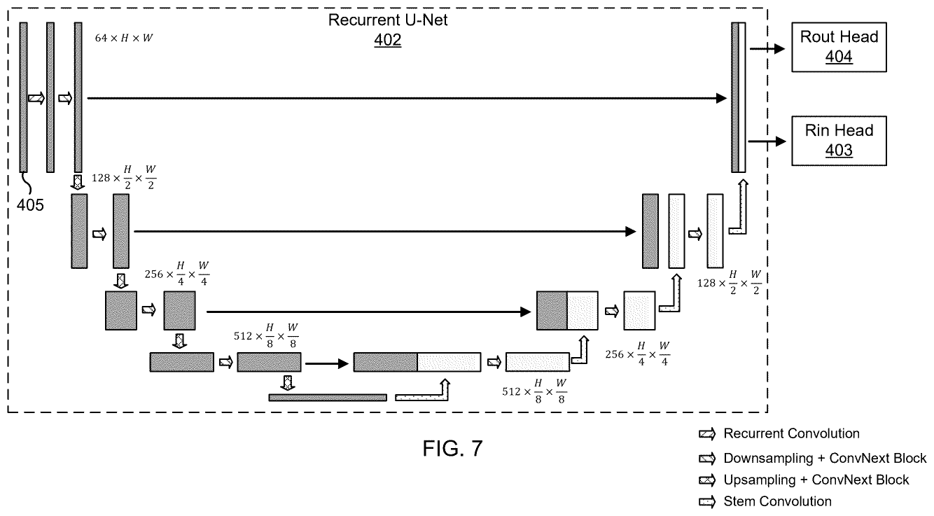

FIG. 7 illustrates the structure of the Recurrent U-Net 402 of FIG. 4 in greater detail. For every ConvNeXt and downsampling block, the Recurrent U-Net 402 has a recurrent convolution to process temporal data. The Recurrent U-Net 402 processes the output Oₜ₋₁ and the temporal reference maps

$${R}_{t - 1}^{i n} and {R}_{t - 1}^{out}$$

at different scales, and adds recurrence to each.

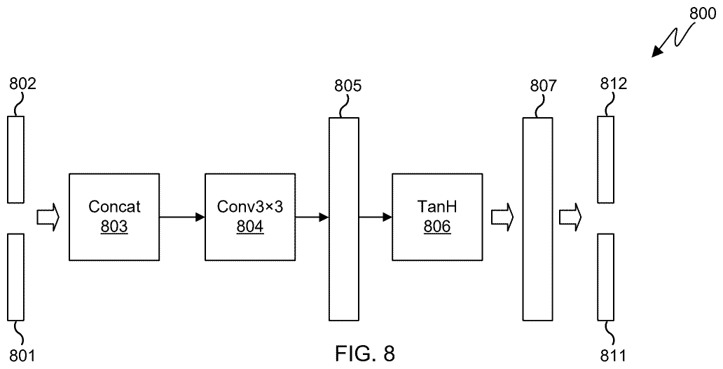

FIG. 8 illustrates the structure of a recurrent convolution layer 800 for use in the Recurrent U-Net 402 of FIGS. 4 and 7. The recurrent convolution layer 800 is a simple and efficient layer which fuses memory 802 along with the input 801 for feature maps. The input 801 is the feature map at different scales and the memory 802 is a tensor fed back to add recurrence. After concatenation by concat 803 and convolution by con3×3 804, the activation function tanh 805 is employed to product output 807, which is parsed into a portion 812 for memory and a portion 811 for output the next layer. The recurrent convolution layer 800 is added in different scales of the U-Net so that the memory mechanism acts at different scales to produce a more accurate and temporally stable output.

Referring back to FIGS. 3 and 4, the steps of the TRN 302 are as follows:
When t=0
   Initialize

$${R}_{- 1}^{i n} = 0 , {R}_{- 1}^{out} = 0 , and {O}_{- 1} = 0 .$$

Set f_{θ} to be a zero-bias convolution network so that

$${R}_{0}^{i n} = 0 , {R}_{0}^{out} = 0 .$$

Here, the image model 301 acts like a vanilla image processing network to produce the output O₀.
When t=1

$${R}_{0}^{in} = 0 , {R}_{0}^{out} = 0 , and {O}_{0} \neq 0 ,$$

which outputs

$${R}_{1}^{in} \neq 0 , {R}_{1}^{out} \neq 0$$

that are similar to

$${O}_{0} as {R}_{0}^{in} = 0 , {R}_{0}^{out} = 0.$$

The output O₁ depends on O₀.
When t=2

$${R}_{1}^{in} \neq 0 , {R}_{1}^{out} \neq 0 , {O}_{1} \neq 0 ,$$

which outputs the new temporal reference maps

$${R}_{2}^{in} \neq 0 , {R}_{1}^{out} \neq 0$$

as a non-linear fusion of

$${R}_{1}^{in} , {R}_{1}^{out} ,$$

and O₁. The new output O₂ depends on

$${R}_{1}^{in} , {R}_{1}^{out} ,$$

### and O₁.

The pattern repeats, until the end of the sequence of frames.
   As shown when t=0, even when the temporal references are zero, the image model works to produce an output, showing that the temporal references are just for reducing flickering of the final video and not a reference image for the image model to process the input as with exemplar-based video colorization, reference-based video super resolution, etc. The reference addition mechanism of the present disclosure achieves that that because no architectural modifications to the image model 301 are made, just changes the input/output to the image model 301.

Using the principles discussed above, any image processing network can be converted into a video processing network with the TRN, making the TRN versatile for any upcoming model. The TRN can be easily applied to real-time use cases, as the current input frame is the only effective input to the network (unlike bi-directional networks, which need the whole video). Even the temporal reference maps are created automatically and a separate network for de-flickering is not required. The TRN can generate temporally stable results without flickering. Where de-flickering networks usually work on videos, the TRN just adds de-flickering adjustment to existing networks.

Temporal reference maps are added to the input and output of the Image model. However, it should be noted that any combination of the maps with the input/output (subtraction, multiplication, fusion with an additional network) is possible. In addition, using just one of the temporal reference maps is also possible for different applications. Two temporal reference maps are described as being used above, which helps with performance and gradient flow. With a single temporal resolution map, the output of a pipeline combining the TRN with an image model may be characterized by Oₜ=g_{Ø}(Iₜ, Rₜ), and the TRN may be characterized by Rₜ=f_{θ}(Rₜ₋₁, Cₜ₋₁), where Rₜ denotes the reference image output at timestep t and Rₜ₋₁ denotes the reference image output at the previous timestep.

In the case of addition, the temporal reference map

$${R}_{t}^{in}$$

should be the same shape as the input Iₜ, and the temporal reference map

$${R}_{t}^{out}$$

should be the same shape as the output O₁. For example, in the case of image colorization, the input is a single channel L image from the Lab color space and the output is a two-channel ab image. In that case,

$${R}_{t}^{in}$$

should be a single channel temporal reference map and

$${R}_{t}^{out}$$

should be a two-channel temporal reference map. The range of values of

$${R}_{t}^{*}$$

is from [−max, max] of the image space to account for addition and subtraction of the reference. For example, if the L-channel has values in the range of [0, 1], then

$${R}_{t}^{in}$$

should be in the range [−1, 1] to account for all the possible changes in pixel values of the input/output, respectively.

Similarly, the resolution of the temporal reference maps may be different as well. For example, for image super resolution in which the input is smaller than the output Oₜ, the temporal reference map

$${R}_{t}^{in}$$

is smaller than the temporal reference map

$${R}_{t}^{out} .$$

It is to be noted that the temporal reference maps are added only to provide temporal information and make the video output smoother with less flickering. There are no architectural modifications to the image net as a result of adding the TRN, so the TRN does not affect the image processing ability of the image model.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
configuring a temporal referencing network (TRN) to add temporal information to an input to an image processing network and to an output of the image processing network, wherein adding the temporal information to the input and the output includes generating multiple temporal reference maps for one or more input images and one or more output images of the image processing network;
determining one or more temporal relations based on applying the multiple temporal reference maps for the one or more input images to a recurrent network of the TRN; and
converting, based on the TRN, the image processing network into an automatic video processing network with temporal stability.

2. The method of claim 1, wherein an implementation of the image processing network remains unmodified, with the temporal information added to the image processing network based on the TRN.

3. The method of claim 1, wherein the image processing network includes at least one of an image colorization network, an image color enhancing network, an image super resolution network, or any similar image-to-image network.

4. The method of claim 1, wherein the multiple temporal reference maps comprise, for a current timestep t, an input temporal reference map from the TRN for the current timestep t and an output temporal reference map from the TRN for the current timestep t.

5. The method of claim 4, wherein converting the image processing network into the automatic video processing network with temporal stability based on the TRN comprises:
for an input image at the current timestep t, adding the input temporal reference map from the TRN for the current timestep t to the input image to generate an input to the image processing network; and
adding the output temporal reference map from the TRN for the current timestep t to an output of the image processing network to generate an output of a pipeline comprising the TRN and the image processing network.

6. The method of claim 5, wherein configuring a temporal referencing network (TRN) to add the temporal information to the input to the image processing network and the output of the image processing network comprises:
generating the input temporal reference map from the TRN and the output temporal reference map from the TRN based on an input temporal reference image from the TRN for a previous timestep t−1, an output temporal reference image from the TRN for the previous timestep t−1, and an output from the pipeline for the previous timestep t−1.

7. The method of claim 6, wherein generating the input temporal reference image from the TRN and the output temporal reference image from the TRN comprises:
performing output-reference (OR) fusion of the input temporal reference image from the TRN for the previous timestep t−1, the output temporal reference image from the TRN for the previous timestep t−1, and the output from the pipeline for the previous timestep t−1; and
operating on an output of the OR fusion with a recurrent convolutional encoder-decoder network (U-Net) to produce outputs used to generate the input temporal reference map from the TRN for the current timestep t and the output temporal reference map from the TRN for the current timestep t.

8. An electronic device comprising:
at least one processing device configured to:
configure a temporal referencing network (TRN) to add temporal information to an input to an image processing network and to an output of the image processing network, wherein adding the temporal information to the input and the output includes generating multiple temporal reference maps for one or more input images and one or more output images of the image processing network;
determine one or more temporal relations based on applying the multiple temporal reference maps for the one or more input images to a recurrent network of the TRN; and
convert, based on the TRN, the image processing network into an automatic video processing network with temporal stability.

9. The electronic device of claim 8, wherein an implementation of the image processing network remains unmodified, with the temporal information added to the image processing network based on the TRN.

10. The electronic device of claim 8, wherein the image processing network includes at least one of an image colorization network, an image color enhancing network, an image super resolution network, or any similar image-to-image network.

11. The electronic device of claim 8, wherein the multiple temporal reference maps comprise, for a current timestep t, an input temporal reference map from the TRN for the current timestep t and an output temporal reference map from the TRN for the current timestep t.

12. The electronic device of claim 11, wherein the at least one processing device is configured to convert the image processing network into the automatic video processing network with temporal stability based on the TRN by:
for an input image at the current timestep t, adding the input temporal reference map from the TRN for the current timestep t to the input image to generate an input to the image processing network; and
adding the output temporal reference map from the TRN for the current timestep t to an output of the image processing network to generate an output of a pipeline comprising the TRN and the image processing network.

13. The electronic device of claim 12, wherein the at least one processing device is configured to configure a temporal referencing network (TRN) to add the temporal information to the input to the image processing network and the output of the image processing network by:
generating the input temporal reference map from the TRN and the output temporal reference map from the TRN based on an input temporal reference image from the TRN for a previous timestep t−1, an output temporal reference image from the TRN for the previous timestep t−1, and an output from the pipeline for the previous timestep t−1.

14. The electronic device of claim 13, wherein the at least one processing device is configured to generate the input temporal reference image from the TRN and the output temporal reference image from the TRN by:
performing output-reference (OR) fusion of the input temporal reference image from the TRN for the previous timestep t−1, the output temporal reference image from the TRN for the previous timestep t−1, and the output from the pipeline for the previous timestep t−1; and
operating on an output of the OR fusion with a recurrent convolutional encoder-decoder network (U-Net) to produce outputs used to generate the input temporal reference map from the TRN for the current timestep t and the output temporal reference map from the TRN for the current timestep t.

15. A non-transitory machine readable medium comprising instructions that when executed cause at least one processing device of an electronic device to:
configure a temporal referencing network (TRN) to add temporal information to an input to an image processing network and to an output of the image processing network, wherein adding the temporal information to the input and the output includes generating multiple temporal reference maps for one or more input images and one or more output images of the image processing network;
determine one or more temporal relations based on applying the multiple temporal reference maps for the one or more input images to a recurrent network of the TRN; and
convert, based on the TRN, the image processing network into an automatic video processing network with temporal stability.

16. The non-transitory machine readable medium of claim 15, wherein an implementation of the image processing network remains unmodified, with the temporal information added to the image processing network based on the TRN.

17. The non-transitory machine readable medium of claim 15, wherein the image processing network includes at least one of an image colorization network, an image color enhancing network, an image super resolution network, or any similar image-to-image network.

18. The non-transitory machine readable medium of claim 15, wherein the multiple temporal reference maps comprise, for a current timestep t, an input temporal reference map from the TRN for the current timestep t and an output temporal reference map from the TRN for the current timestep t.

19. The non-transitory machine readable medium of claim 18, wherein the at least one processing device is configured to convert the image processing network into the automatic video processing network with temporal stability based on the TRN by:
for an input image at the current timestep t, adding the input temporal reference map from the TRN for the current timestep t to the input image to generate an input to the image processing network; and
adding the output temporal reference map from the TRN for the current timestep t to an output of the image processing network to generate an output of a pipeline comprising the TRN and the image processing network.

20. The non-transitory machine readable medium of claim 19, wherein the instructions when executed cause the at least one processing device to configure a temporal referencing network (TRN) to add the temporal information to the input to the image processing network and the output of the image processing network by generating the input temporal reference map from the TRN and the output temporal reference map from the TRN based on an input temporal reference image from the TRN for a previous timestep t−1, an output temporal reference image from the TRN for the previous timestep t−1, and an output from the pipeline for the previous timestep t−1; and
wherein the instructions when executed cause the at least one processing device to generate the input temporal reference image from the TRN and the output temporal reference image from the TRN by:
performing output-reference (OR) fusion of the input temporal reference image from the TRN for the previous timestep t−1, the output temporal reference image from the TRN for the previous timestep t−1, and the output from the pipeline for the previous timestep t−1; and
operating on an output of the OR fusion with a recurrent convolutional encoder-decoder network (U-Net) to produce outputs used to generate the input temporal reference map from the TRN for the current timestep t and the output temporal reference map from the TRN for the current timestep t.
